(19) United States
(12) Patent Application Publication
(10) Pub. No.: US 2026/0342225 A1
(43) Pub. Date: Oct. 29, 2026

(54) DIGITAL DISPLAY STEP-UP THREE-IN-ONE POWER CABLE

(71) Applicant: Shenzhen Jiahong Technology Co., Ltd., Shenzhen (CN)

(72) Inventor: Xiaohua Song, Shenzhen (CN)

(21) Appl. No.: 19/192,858

(22) Filed: Apr. 29, 2025

(51) Int. Cl. H02M 3/155

(52) U.S. Cl. CPC H02M 3/155

(57) ABSTRACT

A digital display step-up three-in-one power cable includes a cigarette lighter plug, a Type-C plug, a DC interface, and a data cable; its internal components include a power management circuit, a step-down voltage regulator circuit, an LCD display drive circuit, a power conversion circuit, a multi-interface power conversion output circuit, a filtering and driving circuit, and a step-up circuit; the power management circuit, the step-down voltage regulator circuit, the filtering and driving circuit, and the step-up circuit are all connected to the 12V power input terminal; the multi-interface power conversion output circuit is provided with a DC5521 input interface and a TYPE-C input interface; an output terminal of the power conversion circuit is connected to an input terminal of the LCD display drive circuit; the filtering and driving circuit is connected to the step-up circuit. The invention integrates multiple interfaces and circuits to achieve compatible power supply.

### 1. TECHNICAL FIELD

The invention relates to the technical field of charging of vehicle power supply equipment and mobile devices, in particular to a digital display step-up three-in-one power cable.

### 2. BACKGROUND ART

With the diversification of electronic devices, power cables have evolved from simple conductivity to integration and multifunctionality. Products with multiple interfaces such as Type-C and DC meet the needs of interconnection among multiple devices, and some of them integrate filtering or voltage-stabilizing circuits. However, with the popularization of high-power devices, the input power supply experiences voltage drops due to the attenuation of the battery voltage or long-line transmission. Traditional power cables have difficulty in stably outputting power under low input voltages, and there are technical gaps in the coordinated control and status monitoring of multiple interfaces.

The existing technical deficiencies are as follows: firstly, there is a lack of an efficient voltage conversion mechanism for power supply in multiple scenarios, and low voltage or line losses are likely to cause abnormal operation of devices. Secondly, the protection circuit for the reverse input of high voltage at the Type-C interface has a complex structure or insufficient reliability. Thirdly, most products do not have an intuitive display of the power status, and the coordinated control of various modules and electromagnetic compatibility need to be optimized.

### 3. SUMMARY OF THE INVENTION

The object of the invention is to overcome the above-mentioned problems and provide a digital display step-up three-in-one power cable. In order to achieve the above object, the invention adopts the following technical solutions: a digital display step-up three-in-one power cable includes a cigarette lighter plug, a Type-C plug, a DC interface, and a data cable; its internal components include a power management circuit, a step-down voltage regulator circuit, an LCD display drive circuit, a power conversion circuit, a multi-interface power conversion output circuit, a filtering and driving circuit, and a step-up circuit; the power management circuit, the step-down voltage regulator circuit, the filtering and driving circuit, and the step-up circuit are all connected to the 12V power input terminal; the multi-interface power conversion output circuit is provided with a DC5521 input interface and a TYPE-C input interface; an output terminal of the power conversion circuit is connected to an input terminal of the LCD display drive circuit; the filtering and driving circuit is connected to the step-up circuit.

The power management circuit includes a 12V power input terminal, the input terminal is electrically connected to one end of an inductor L2, a capacitor C5, a capacitor C6, and a resistor R3 respectively; an other end of the capacitor C5 is electrically connected to the ground, an other end of the capacitor C6 is connected to a chip OM6125; an other end of the resistor R3 is electrically connected to one end of a capacitor C7, and an other end of the capacitor C7 is electrically connected to the ground; an other end of the inductor L2 is electrically connected to one end of a capacitor EC4 and an interface USB1 respectively; an other end of the capacitor EC4 is electrically connected to the ground; the chip OM6125 is electrically connected to the 12V power input terminal and the interface USB1 respectively.

The step-down voltage regulator circuit includes a 12V power input terminal, the input terminal is connected to one end of a capacitor C26 and a chip IP6535, an other end of the capacitor C26 is connected to the ground; the chip IP6535 is connected to one end of an inductor L3; an other end of the inductor L3 is connected to a positive pole of a capacitor EC5, an output terminal OUTA, and a USB2 interface; a negative pole of the capacitor EC5 is connected to the ground.

The LCD display drive circuit includes a power input terminal, a capacitor C3, a chip EC3, and an LCD display screen LCD1; the power input terminal is connected to one end of the capacitor C3, and an other end of the capacitor C3 is connected to the ground; the power input terminal is connected to the chip EC3; the chip EC3 is connected to the LCD display screen LCD1.

The power conversion circuit includes a 12V power input terminal, a resistor R1, a resistor R2, a capacitor C1, a capacitor C2, a capacitor C4, and a power conversion module J2; the power conversion module J2 adopts ME6203-50, the 12V power input terminal is connected to the resistor R2, the capacitor C1, and the power conversion module J2 respectively; an other end of the resistor R2 is connected to the IN_AD interface, one end of the resistor R1, and one end of the capacitor C4 respectively; other ends of the resistor R1, the capacitor C1, and the capacitor C4 are all connected to the ground; an output terminal of the power conversion module J2 outputs VCC_5.0V and is connected to one end of the capacitor C2, and an other end of the capacitor C2 is connected to the ground.

The multi-interface power conversion output circuit includes a DC5521 input interface, a TYPE-C input interface, a capacitor C8, a capacitor C9, a capacitor EC1, an input terminal, a MOS tube Q2, a resistor R9, a capacitor C39, and an output terminal; the DC5521 input interface and the TYPE-C input interface are respectively connected to a diode, the diode is connected to the input terminal, the input terminal is connected to a MOS tube Q2 and a resistor R9, the resistor R9 is connected to the capacitor C39, the capacitor C8, the capacitor C9, and the capacitor EC1; the capacitor C8, the capacitor C9, and the capacitor EC1 are connected in parallel with each other, and an other end is connected to the ground.

The filtering and driving circuit includes a positive input terminal, a negative input terminal, a 12V power supply, a capacitor EC2, a capacitor C11, a capacitor C12, a capacitor C10, a resistor R10, a resistor R14, a diode D5, a diode D1, and a MOS tube Q8, and a MOS tube Q3; the positive input terminal is connected to the 12V power supply, the positive input terminal is also connected to one end of the capacitor EC2, the capacitor C11, the capacitor C12, and the capacitor C10 respectively; the negative input terminal is connected to an other end of the capacitor EC2, the capacitor C11, the capacitor C12, and the capacitor C10 respectively; one end of the resistor R10 is connected to an HG1 interface, and an other end thereof is connected to the diode D5, and an other end of the diode D5 is connected to the MOS tube Q8; one end of the resistor R14 is connected to an LG1 interface and is connected in parallel with the diode D1, and an other end of the diode D1 is connected to the MOS tube Q3.

The step-up circuit includes a 12V power input terminal, a chip PL5501, an inductor L1, a capacitor C18, a capacitor C19, a capacitor C20, an interface HG1, an interface LG1, and an interface LG2; the 12V power input terminal is connected to one end of the capacitor C18, and an other end of the capacitor C18 is connected to the ground; the chip PL5501 is connected to the inductor L1, the interfaces HG1, LG1, and LG2 are respectively connected to the chip PL5501; the chip PL5501 is connected to the output terminal through the capacitor C19 and the capacitor C20.

Advantages of the invention lies in the following:

1. through the setting of multiple interfaces such as a cigarette lighter plug, a Type-C plug, and a DC interface, as well as a multi-interface power conversion output circuit, and in cooperation with a step-up circuit that boosts the voltage above 11.3V to 20V5A, the present invention achieves compatible power supply for devices with different interfaces in multiple scenarios such as in-vehicle devices, mobile devices, and other DC devices. It effectively solves the problem that devices cannot operate due to low battery voltage and wire loss, and meets diverse power consumption requirements.

2. The invention processes the 12V power supply through a power management circuit, a step-down voltage regulator circuit, a power conversion circuit, etc., and combines with an LCD display drive circuit to display the voltage and current in real time. It realizes the hierarchical conversion and stable output of the power supply, provides adapted power supplies for different modules, and at the same time enables users to intuitively understand the working status of the power cable, improving the convenience and reliability of use.

3.The invention realizes effective protection of components such as the Type-C chip by setting up circuit protection at the Type-C input interface, using a diode to prevent reverse input of high voltage, and connecting filter capacitors and grounding terminals in each circuit to each other. It reduces electromagnetic interference, improves the safety and stability of the power cable, and ensures the normal operation of the device and the circuit.

### 4. BRIEF DESCRIPTION OF ACCOMPANY DRAWINGS

FIG. 1 is a structural diagram of a digital display step-up three-in-one power cable of embodiment 1 provided by the invention.

FIG. 2 is a diagram of a power management circuit of a digital display step-up three-in-one power cable of embodiment 1 provided by the invention.

FIG. 3 is a diagram of a step-down voltage regulator circuit of a digital display step-up three-in-one power cable of embodiment 1 provided by the invention.

FIG. 4 is a diagram of an LCD display drive circuit of a digital display step-up three-in-one power cable of embodiment 1 provided by the invention.

FIG. 5 is a diagram of a power conversion circuit of a digital display step-up three-in-one power cable of embodiment 1 provided by the invention.

FIG. 6 is a diagram of a multi-interface power conversion output circuit of a digital display step-up three-in-one power cable of embodiment 1 provided by the invention.

FIG. 7 is a diagram of a filtering and driving circuit of a digital display step-up three-in-one power cable of embodiment 1 provided by the invention.

FIG. 8 is a diagram of a step-up circuit of a digital display step-up three-in-one power cable of embodiment 1 provided by the invention.

As shown in the accompanying drawings:
1 cigarette lighter plug, 2 Type-C plug, 3 DC interface, 4 data cable.

### 5. SPECIFIC EMBODIMENT OF THE INVENTION

In order to make the objects, technical solutions and advantages of the embodiments of the present invention clearer, the technical solutions in the embodiments of the invention will be clearly and completely described below with reference to the drawings in the embodiments of the invention, and it is obvious that the described embodiments are some, but not all, embodiments of the invention. The components of embodiments of the invention generally described and illustrated in the figures herein may be arranged and designed in a wide variety of different configurations.

### Embodiment 1

The embodiment discloses a digital display step-up three-in-one power cable.

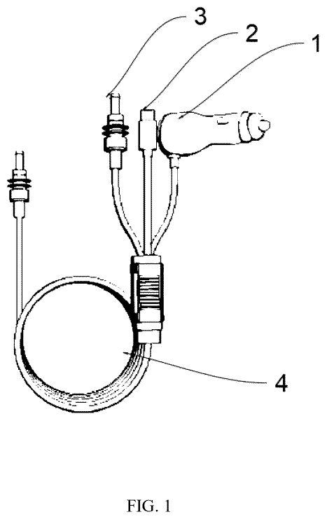

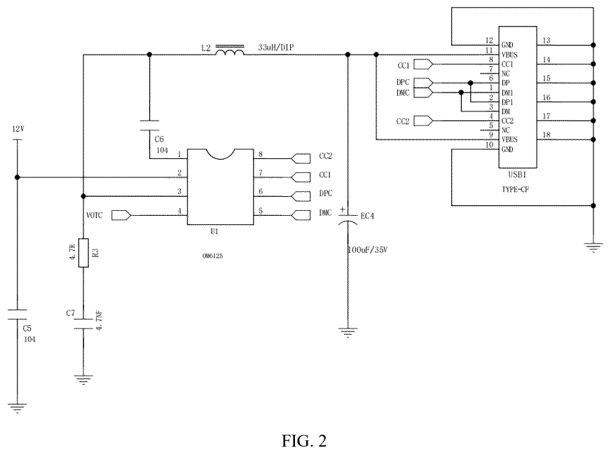

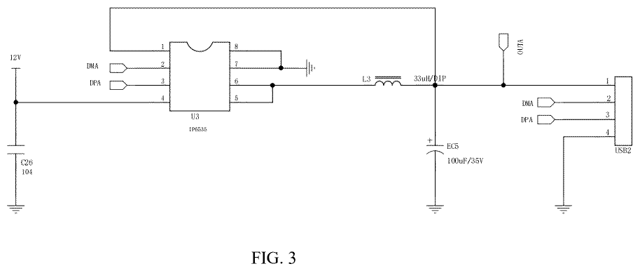

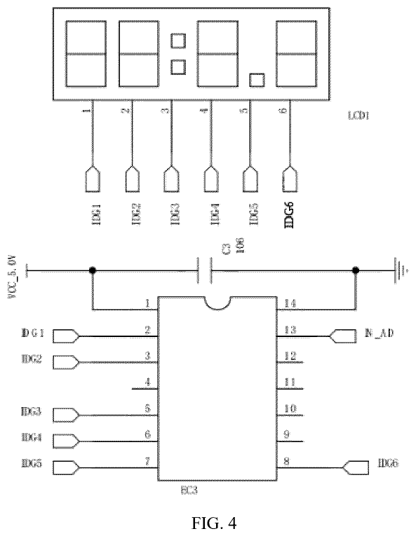

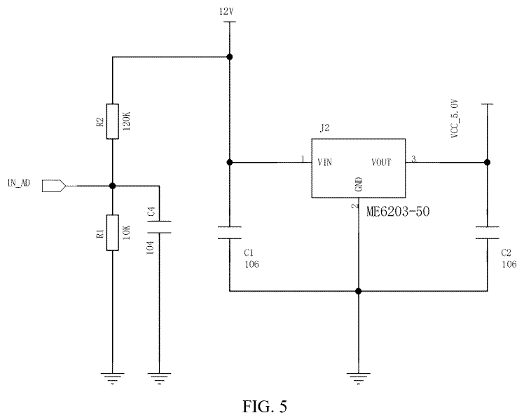

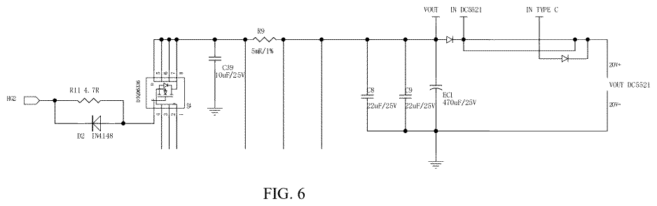

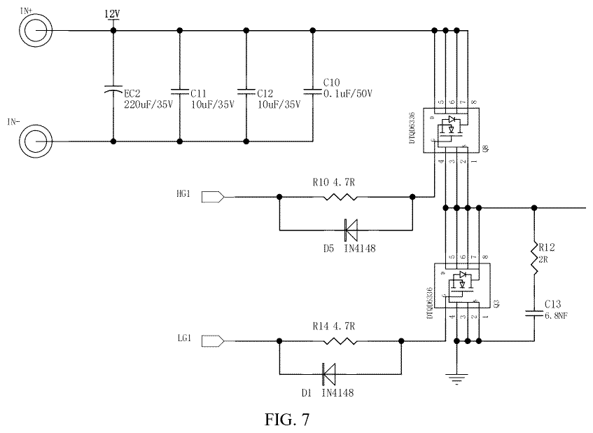

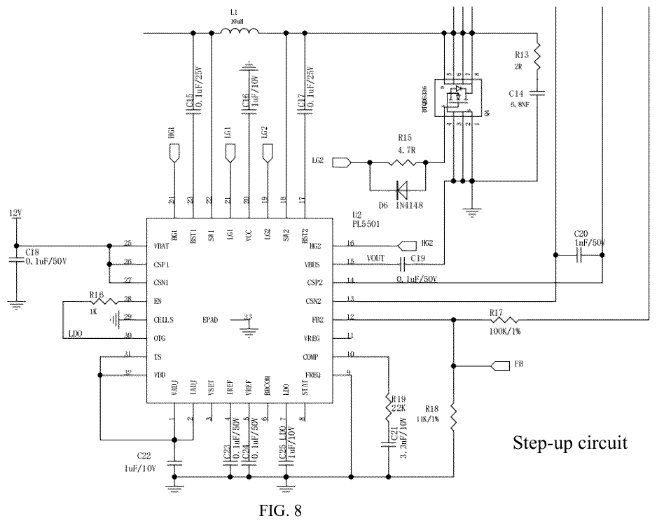

As shown in FIGS. 1-8, a digital display step-up three-in-one power cable includes a cigarette lighter plug 1, a Type-C plug 2, a DC interface 3, and a data cable 4; its internal components include a power management circuit, a step-down voltage regulator circuit, an LCD display drive circuit, a power conversion circuit, a multi-interface power conversion output circuit, a filtering and driving circuit, and a step-up circuit; the power management circuit, the step-down voltage regulator circuit, the filtering and driving circuit, and the step-up circuit are all connected to the 12V power input terminal; the multi-interface power conversion output circuit is provided with a DC5521 input interface and a TYPE-C input interface; an output terminal of the power conversion circuit is connected to an input terminal of the LCD display drive circuit; the filtering and driving circuit is connected to the step-up circuit.

The power management circuit includes a 12V power input terminal, the input terminal is electrically connected to one end of an inductor L2, a capacitor C5, a capacitor C6, and a resistor R3 respectively; an other end of the capacitor C5 is electrically connected to the ground, an other end of the capacitor C6 is connected to a chip OM6125; an other end of the resistor R3 is electrically connected to one end of a capacitor C7, and an other end of the capacitor C7 is electrically connected to the ground; an other end of the inductor L2 is electrically connected to one end of a capacitor EC4 and an interface USB1 respectively; an other end of the capacitor EC4 is electrically connected to the ground; the chip OM6125 is electrically connected to the 12V power input terminal and the interface USB1 respectively.

Through the combination of multi-stage filtering elements and the inductive energy storage design, the circuit effectively suppresses the high-frequency ripple and electromagnetic interference in the power input, provides a stable 12V power supply for the USB1 interface output, improves the power supply quality of external devices, and avoids abnormal device operation caused by power fluctuations. It is especially suitable for scenarios with high requirements for power stability.

The step-down voltage regulator circuit includes a 12V power input terminal, the input terminal is connected to one end of a capacitor C26 and a chip IP6535, an other end of the capacitor C26 is connected to the ground; the chip IP6535 is connected to one end of an inductor L3; an other end of the inductor L3 is connected to a positive pole of a capacitor EC5, an output terminal OUTA, and a USB2 interface; a negative pole of the capacitor EC5 is connected to the ground.

The circuit uses the step-down control function of the chip IP6535 to convert the 12V input voltage into a stable low voltage required by the device; through the energy storage characteristics of the inductor and the filtering function of the capacitor, it realizes a low-ripple and high-efficiency step-down output, provides a suitable power supply for the low-voltage devices at the OUTA terminal and the USB2 interface, solves the direct connection contradiction between high input voltage and low-voltage device, and improves the safety and stability of the charging process.

The LCD display drive circuit includes a power input terminal, a capacitor C3, a chip EC3, and an LCD display screen LCD1; the power input terminal is connected to one end of the capacitor C3, and an other end of the capacitor C3 is connected to the ground; the power input terminal is connected to the chip EC3; the chip EC3 is connected to the LCD display screen LCD1.

The circuit isolates interference of the main circuit through the independent filtering capacitor C3, ensures the stability of the power supply of a display module, avoids the influence of voltage fluctuations on the display effect, and realizes the real-time visual display of key parameters such as input and output voltage and current, so that users can directly grasp the working status of the power cable without the need for additional equipment, and can promptly detect power abnormalities or load changes, which improves the human-computer interaction experience and use convenience of the product.

The power conversion circuit includes a 12V power input terminal, a resistor R1, a resistor R2, a capacitor C1, a capacitor C2, a capacitor C4, and a power conversion module J2; the power conversion module J2 adopts ME6203-50, the 12V power input terminal is connected to the resistor R2, the capacitor C1, and the power conversion module J2 respectively; an other end of the resistor R2 is connected to the IN_AD interface, one end of the resistor R1, and one end of the capacitor C4 respectively; other ends of the resistor R1, the capacitor C1, and the capacitor C4 are all connected to the ground; an output terminal of the power conversion module J2 outputs VCC_5.0V and is connected to one end of the capacitor C2, and an other end of the capacitor C2 is connected to the ground.

This circuit provides a dedicated 5V low-voltage power supply for the LCD display drive circuit and other logic control chips; through the cooperation of multi-stage RC filtering network and a linear voltage regulator module, it effectively reduces the power noise, ensures the high precision and low fluctuation of the output voltage, and meets the working requirements of integrated circuits with strict requirements for voltage stability.

The multi-interface power conversion output circuit includes a DC5521 input interface, a TYPE-C input interface, a capacitor C8, a capacitor C9, a capacitor EC1, an input terminal, a MOS tube Q2, a resistor R9, a capacitor C39, and an output terminal; the DC5521 input interface and the TYPE-C input interface are respectively connected to a diode, the diode is connected to the input terminal, the input terminal is connected to a MOS tube Q2 and a resistor R9, the resistor R9 is connected to the capacitor C39, the capacitor C8, the capacitor C9, and the capacitor EC1; the capacitor C8, the capacitor C9, and the capacitor EC1 are connected in parallel with each other, and an other end is connected to the ground.

The circuit supports bidirectional power input of a vehicle-mounted cigarette lighter DC5521 and Type-C devices; through the unidirectional conduction protection of the diode and the high-frequency filtering of the capacitor group, it realizes safe switching and stable processing of multi-source input, solves the compatibility problem caused by the difference in power specifications of different interface devices, and is suitable for complex scenarios that require simultaneous connection of multiple external power supplies.

The filtering and driving circuit includes a positive input terminal, a negative input terminal, a 12V power supply, a capacitor EC2, a capacitor C11, a capacitor C12, a capacitor C10, a resistor R10, a resistor R14, a diode D5, a diode D1, and a MOS tube Q8, and a MOS tube Q3; the positive input terminal is connected to the 12V power supply, the positive input terminal is also connected to one end of the capacitor EC2, the capacitor C11, the capacitor C12, and the capacitor C10 respectively; the negative input terminal is connected to an other end of the capacitor EC2, the capacitor C11, the capacitor C12, and the capacitor C10 respectively; one end of the resistor R10 is connected to an HG1 interface, and an other end thereof is connected to the diode D5, and an other end of the diode D5 is connected to the MOS tube Q8; one end of the resistor R14 is connected to an LG1 interface and is connected in parallel with the diode D1, and an other end of the diode D1 is connected to the MOS tube Q3.

The design of multiple capacitors connected in parallel effectively filters out the high-frequency noise waves and low-frequency ripple in the 12V power supply, and improves the purity of the input power supply; the combination of resistor current limiting, diode unidirectional conduction, and MOS tube switch control forms a driving signal conditioning link for the step-up circuit, improves the power conversion efficiency, reduces the circuit loss, and ensures the reliable operation of the step-up module.

The step-up circuit includes a 12V power input terminal, a chip PL5501, an inductor L1, a capacitor C18, a capacitor C19, a capacitor C20, an interface HG1, an interface LG1, and an interface LG2; the 12V power input terminal is connected to one end of the capacitor C18, and an other end of the capacitor C18 is connected to the ground; the chip PL5501 is connected to the inductor L1, the interfaces HG1, LG1, and LG2 are respectively connected to the chip PL5501; the chip PL5501 is connected to the output terminal through the capacitor C19 and the capacitor C20.

The circuit uses the high-frequency switch control of the chip PL5501 and the energy storage characteristics of the inductor L1 to step up the input voltage above 11.3V to the high voltage required by the device. With the cooperation of the capacitor filtering at the output terminal, it effectively compensates for the voltage drop problem caused by the battery voltage attenuation and long-line transmission, realizes a stable high-voltage and large-current output, and ensures the normal operation of the device in a complex power environment.

The invention and its embodiments have been described above, but the description is not limited thereto; only one embodiment of the invention is shown in the drawings, and the actual structure is not limited thereto. In general, it is to be understood by those skilled in the art that non-creative design of structural forms and embodiments that are similar to the technical solutions without departing from the spirit of the invention shall all fall within the protective scope of the invention.

1. A digital display step-up three-in-one power cable, including a cigarette lighter plug, a Type-C plug, a DC interface, and a data cable; its internal components include a power management circuit, a step-down voltage regulator circuit, an LCD display drive circuit, a power conversion circuit, a multi-interface power conversion output circuit, a filtering and driving circuit, and a step-up circuit; the power management circuit, the step-down voltage regulator circuit, the filtering and driving circuit, and the step-up circuit are all connected to the 12V power input terminal; the multi-interface power conversion output circuit is provided with a DC5521 input interface and a TYPE-C input interface; an output terminal of the power conversion circuit is connected to an input terminal of the LCD display drive circuit; the filtering and driving circuit is connected to the step-up circuit.

2. The digital display step-up three-in-one power cable of claim 1, wherein power management circuit includes a 12V power input terminal, the input terminal is electrically connected to one end of an inductor L2, a capacitor C5, a capacitor C6, and a resistor R3 respectively; another end of the capacitor C5 is electrically connected to the ground, another end of the capacitor C6 is connected to a chip OM6125; another end of the resistor R3 is electrically connected to one end of a capacitor C7, and another end of the capacitor C7 is electrically connected to the ground; another end of the inductor L2 is electrically connected to one end of a capacitor EC4 and an interface USB1 respectively; another end of the capacitor EC4 is electrically connected to the ground; the chip OM6125 is electrically connected to the 12V power input terminal and the interface USB1 respectively.

3. The digital display step-up three-in-one power cable of claim 2, wherein the step-down voltage regulator circuit includes a 12V power input terminal, the input terminal is connected to one end of a capacitor C26 and a chip IP6535, another end of the capacitor C26 is connected to the ground; the chip IP6535 is connected to one end of an inductor L3; another end of the inductor L3 is connected to a positive pole of a capacitor EC5, an output terminal OUTA, and a USB2 interface; a negative pole of the capacitor EC5 is connected to the ground.

4. The digital display step-up three-in-one power cable of claim 3, wherein the LCD display drive circuit includes a power input terminal, a capacitor C3, a chip EC3, and an LCD display screen LCD1; the power input terminal is connected to one end of the capacitor C3, and another end of the capacitor C3 is connected to the ground; the power input terminal is connected to the chip EC3; the chip EC3 is connected to the LCD display screen LCD1.

5. The digital display step-up three-in-one power cable of claim 4, wherein the power conversion circuit includes a 12V power input terminal, a resistor R1, a resistor R2, a capacitor C1, a capacitor C2, a capacitor C4, and a power conversion module J2; the power conversion module J2 adopts ME6203-50, the 12V power input terminal is connected to the resistor R2, the capacitor C1, and the power conversion module J2 respectively; another end of the resistor R2 is connected to the IN_AD interface, one end of the resistor R1, and one end of the capacitor C4 respectively;
other ends of the resistor R1, the capacitor C1, and the capacitor C4 are all connected to the ground; an output terminal of the power conversion module J2 outputs VCC_5.0V and is connected to one end of the capacitor C2, and another end of the capacitor C2 is connected to the ground.

6. The digital display step-up three-in-one power cable of claim 5, wherein the multi-interface power conversion output circuit includes a DC5521 input interface, a TYPE-C input interface, a capacitor C8, a capacitor C9, a capacitor EC1, an input terminal, a MOS tube Q2, a resistor R9, a capacitor C39, and an output terminal; the DC5521 input interface and the TYPE-C input interface are respectively connected to a diode, the diode is connected to the input terminal, the input terminal is connected to a MOS tube Q2 and a resistor R9, the resistor R9 is connected to the capacitor C39, the capacitor C8, the capacitor C9, and the capacitor EC1; the capacitor C8, the capacitor C9, and the capacitor EC1 are connected in parallel with each other, and another end is connected to the ground.

7. The digital display step-up three-in-one power cable of claim 6, wherein the filtering and driving circuit includes a positive input terminal, a negative input terminal, a 12V power supply, a capacitor EC2, a capacitor C11, a capacitor C12, a capacitor C10, a resistor R10, a resistor R14, a diode D5, a diode D1, and a MOS tube Q8, and a MOS tube Q3; the positive input terminal is connected to the 12V power supply, the positive input terminal is also connected to one end of the capacitor EC2, the capacitor C11, the capacitor C12, and the capacitor C10 respectively; the negative input terminal is connected to an other end of the capacitor EC2, the capacitor C11, the capacitor C12, and the capacitor C10 respectively; one end of the resistor R10 is connected to an HG1 interface, and another end thereof is connected to the diode D5, and another end of the diode D5 is connected to the MOS tube Q8; one end of the resistor R14 is connected to an LG1 interface and is connected in parallel with the diode D1, and another end of the diode D1 is connected to the MOS tube Q3.

8. The digital display step-up three-in-one power cable of claim 7, wherein the step-up circuit includes a 12V power input terminal, a chip PL5501, an inductor L1, a capacitor C18, a capacitor C19, a capacitor C20, an interface HG1, an interface LG1, and an interface LG2; the 12V power input terminal is connected to one end of the capacitor C18, and another end of the capacitor C18 is connected to the ground; the chip PL5501 is connected to the inductor L1, the interfaces HG1, LG1, and LG2 are respectively connected to the chip PL5501; the chip PL5501 is connected to the output terminal through the capacitor C19 and the capacitor C20.
